(19) United States
(12) Patent Application Publication
(10) Pub. No.: US 2016/0330022 A1
(43) Pub. Date: Nov. 10, 2016

(54) CRYPTOGRAPHIC SYSTEM, KEY GENERATION APPARATUS, RE-ENCRYPTION APPARATUS AND USER TERMINAL

(71) Applicant: MITSUBISHI ELECTRIC CORPORATION, Tokyo (JP)

(72) Inventors: Takashi ITO, Tokyo (JP); Sachihiro ICHIKAWA, Tokyo (JP); Takumi MORI, Tokyo (JP); Yutaka KAWAI, Tokyo (JP); Katsuyuki TAKASHIMA, Tokyo (JP)

(73) Assignee: MITSUBISHI ELECTRIC CORPORATION, Tokyo (JP)

(21) Appl. No.: 15/104,713

(22) PCT Filed: Jan. 16, 2014
(86) PCT No.: PCT/JP2014/050626

§ 371 Date: Jun. 15, 2016

(51) Int. Cl. H04L 9/08; H04L 9/06

(52) U.S. Cl. CPC H04L 9/0861; H04L 9/0618; H04L 2209/12

(57) ABSTRACT

A cryptographic system (10) uses a cryptographic scheme capable of decrypting ciphertext on which one of two pieces of information corresponding to each other is set, with a decryption key on which the other piece of information is set. A key generation apparatus (401) generates a user private key on which one of key information u and key information y corresponding to each other is set, and a re-encryption key to convert ciphertext which can be decrypted with an attribute private key on which one of user attribute information x and user attribute information v corresponding to each other is set, into a re-ciphertext on which the other of the key information u and the key information y is set. A ciphertext storage apparatus (201) stores ciphertext on which the other of the user attribute information x and the user attribute information v is set. A re-encryption apparatus (301) re-encrypts the ciphertext stored in the ciphertext storage apparatus with the re-encryption key to generate the re-ciphertext. A user terminal (601) decrypts the re-ciphertext with the user private key.

### TECHNICAL FIELD

The present invention relates to a cryptographic system to implement invalidation of keys.

### BACKGROUND ART

The popularization of cloud services has been encouraging storage of data, whether personal or corporate, in external cloud servers. It is a common practice to store encrypted data, in cloud servers to prevent personal information or trade secrets from leaking out.

There is functional encryption in which data can be encrypted with a specific decryption condition so that only the user who satisfies the decryption condition can decrypt the ciphertext. Functional encryption allows a data creator to control the access right, which is suitable for a company or the like dealing with a lot of different types of data in confidentiality or in the extent of disclosure, to use cloud services.

In a company or the like, the access right of a user may change according to personnel transfer or retirement, the private key stored in the employee ID card, for example, may be lost, or the like. In such cases, user or key invalidation which is a “process to prevent data from being read by the user or key any more” is required.

Especially, when a cloud server is used like a shared file server, it is likely that the whole pieces of data, past and present, are stored in the cloud server. Therefore, a leaked private key may cause a risk of giving away the whole pieces of past data. This requires some measures to be taken.

A possible method for simple invalidation is as follows: a company or the like decrypts all the ciphertext in the cloud server, then re-encrypts the data so as not to be read with an invalidated key, and then re-stores the data back in the cloud server. This, however, involves a large volume of data to be sent/received and to be encrypted, in each process of invalidation, and is therefore inefficient.

Patent Document 1 discloses that ciphertext in a cloud server is passed not directly to the users but through conversion (re-encryption) into ciphertext directed to each individual user, using a “re-encryption key” which allows the address of ciphertext, as encrypted, to be changed. The application of the technology disclosed in Patent Document 1 may allow invalidation to be implemented through the management of re-encryption keys.

### CITATION LIST

### Patent Literature

Patent Document 1: JP 2012-169978 A

### Non-Patent Literature

Non-Patent Document 1: “Functional Proxy-Re-Encryption”, Yutaka Kawai and Katsuyuki Takashima, The 30th Symposium on Cryptography and Information Security (SCIS 2013), issued on Jan. 22, 2013

### SUMMARY OF INVENTION

### Technical Problem

Patent Document 1 uses a re-encryption system in public key cryptography, such as RSA cryptography or ID based cryptography, where a public key and a private key have a one-to-one relationship.

Therefore, if one user belongs to two or more groups in a company or the like, two or more re-encryption keys need to be managed for that one user. In the case of the user who is “Section chief” at the “General Affairs Department” and whose year of employment is “2000”, for example, the following three re-encryption keys need to be managed: a “re-encryption key to re-encrypt ciphertext addressed to the general affairs department so that ciphertext is addressed to user A”, a “re-encryption key to re-encrypt ciphertext addressed to section chiefs so that the ciphertext is addressed to user A”, and a “re-encryption key to re-encrypt ciphertext addressed to employees joined in the company in 2000 so that the ciphertext is addressed to user A”.

If the access right is to be set as an AND condition of a group, a re-encryption key for a group corresponding to the AND condition also needs to be managed. For example, if encryption is to be done so that only “section chiefs at the general affairs department” can read, a “re-encryption key to re-encrypt ciphertext addressed to section chiefs at the general affairs department so that the ciphertext is addressed to user A” needs to be managed. Thus, a large number of re-encryption keys need to be managed to set a flexible access right based on combinations of AND and OR conditions, which sounds impracticable.

Non-Patent Document 1 discloses a re-encryption system in functional encryption. In functional encryption, a public key and a private key have a many-to-many relationship, which is different from RSA cryptography or ID based cryptography in which a public key and a private key have a one-to-one relationship. Therefore, the system of Non-Patent Document 1 cannot be applied simply to the system of Patent Document 1.

An objective of the present invention is to enable user or key invalidation to be implemented efficiently in a cryptographic scheme capable of flexible access control, such as functional encryption.

### Solution to Problem

A cryptographic system according to this invention uses a cryptographic scheme capable of decrypting ciphertext on which one of two pieces of information corresponding to each other is set, with a decryption key on which the other of the two pieces of information is set. The cryptographic system may include:

a key generation apparatus to generate a user private key on which one of key information u and key information y corresponding to each other is set, and a re-encryption key to convert ciphertext which can be decrypted with an attribute private key on which one of user attribute information x and user attribute information v corresponding to each other is set, into re-ciphertext on which the other of the key information u and the key information y is set;

a ciphertext storage apparatus to store ciphertext on which the other of the user attribute information x and the user attribute information v is set;

a re-encryption apparatus to re-encrypt the ciphertext stored in the ciphertext storage apparatus, with the re-encryption key generated by the key generation apparatus to generate the re-ciphertext; and

a user terminal to decrypt the re-ciphertext generated by the re-encryption apparatus, with the user private key generated by the key generation apparatus.

### Advantageous Effects of Invention

A cryptographic system according to this invention may implement user or key invalidation efficiently with a re-encryption technology in conjunction with flexible access control by a cryptographic scheme such as functional encryption.

### BRIEF DESCRIPTION OF DRAWINGS

FIG. 1 is a diagram illustrating a configuration of a cryptographic system 10 according to a first embodiment.

FIG. 2 is a diagram illustrating a configuration of a ciphertext storage apparatus 201 according to the first embodiment.

FIG. 3 is a diagram illustrating an example of information stored in a ciphertext storage section 211.

FIG. 4 is a diagram illustrating a re-encryption apparatus 301 according to the first embodiment.

FIG. 5 is a diagram illustrating an example of information stored in a public parameter storage section 311.

FIG. 6 is a diagram illustrating an example of information stored in a re-encryption key storage section 312.

FIG. 7 is a diagram illustrating a configuration of a key generation apparatus 401 according to the first embodiment.

FIG. 8 is a diagram illustrating an example of information stored in a master key information storage section 411.

FIG. 9 is a diagram illustrating an example of information stored in a key information storage section 412.

FIG. 10 is a diagram illustrating an example of information stored in an authentication information storage section 413.

FIG. 11 is a diagram illustrating a configuration of an attribute management apparatus 501 according to the first embodiment.

FIG. 12 is a diagram illustrating an example of information stored in an attribute information storage section 511.

FIG. 13 is a diagram illustrating an example of information stored in an authentication information storage section 512.

FIG. 14 is a diagram illustrating a configuration of a user terminal 601 according to the first embodiment.

FIG. 15 is a diagram illustrating an example of information stored in a public parameter storage section 611.

FIG. 16 is a diagram illustrating an example of information stored in a user private key storage section 612.

FIG. 17 is a flow chart illustrating a flow of default setting for the whole system.

FIG. 18 is a flow chart illustrating a flow of user registration.

FIG. 19 is a flow chart illustrating a flow of data registration.

FIG. 20 is a flow chart illustrating a flow of data acquisition.

FIG. 21 is a flow chart illustrating a flow of user private key updating.

FIG. 22 is a diagram illustrating an example of information stored in the key information storage section 412.

FIG. 23 is a diagram illustrating an example of information stored in the user private key storage section 612.

FIG. 24 is a diagram illustrating an example of information stored in the re-encryption key storage section 312.

FIG. 25 is a flow chart illustrating a flow of user attribute updating.

FIG. 26 is a diagram illustrating an example of information stored in the attribute information storage section 511.

FIG. 27 is a diagram illustrating an example of information stored in the key information storage section 412.

FIG. 28 is a diagram illustrating an example of information stored in the re-encryption key storage section 312.

FIG. 29 is a diagram illustrating an example of the hardware configuration of any one of the ciphertext storage apparatus 201, the re-encryption apparatus 301, the key generation apparatus 401, the attribute management apparatus 501 and the user terminal 601, described in the first embodiment.

### DESCRIPTION OF EMBODIMENTS

### Embodiment 1

In the following discussion, a re-encryption system in functional encryption (see Non-Patent Document 1) is used as a cryptographic scheme. The re-encryption system in functional encryption allows the address of data encrypted through functional encryption to be changed as the data is encrypted.

The re-encryption system in functional encryption has the following features (1) and (2):

(1) An encryption key and a decryption key have information x and information v set thereon, respectively. Only when the information x and the information v correspond to each other, a decryption key dk_{V} can decrypt ciphertext which has been encrypted with an encryption key ekₓ.

(2) In addition to the information x and the information v set on the encryption key and the decryption key, two pieces of information (u, v) are set on a re-encryption key. Only when the information x and the information v correspond to each other, a re-encryption key rk_{(u,v)} can convert ciphertext which has been encrypted with the encryption key ekₓ into ciphertext which has been encrypted with an encryption key ekᵤ.

Referring further to the information x and the information v, one is a policy (a decryption condition) and the other is an input value for the policy, for example. In this case, the information x and the information v correspond to each other means the input value satisfies the policy.

The re-encryption system in functional encryption includes a ciphertext-policy based system where a policy is set on ciphertext, and a key-policy based system where a policy is set on a decryption key.

For example, in the case of the ciphertext-policy based system, the decryption condition relating to the attribute of the user, like “Decryption can be done only by General affairs department or Heads of departments”, is set on the ciphertext, and attribute information of the user, like “Department=General affairs, Position=Secton chief, Year of Employment=2000”, is set on the decryption key. In the case of the key-policy based system, the attribute information of the user, like “Department=General affairs, Position=Secton chief, Year of Employment=2000”, is set on the ciphertext, and the decryption condition related to the attribute of the user, like “Decryption can be done only by General affairs department or Heads of departments”, is set on the decryption key.

In the discussion herein, the ciphertext-policy based system is used. However, a system using the key-policy based system can be implemented simply by switching information to be set between the encryption key and the decryption key.

Alternatively, any re-encryption system other than that disclosed in Non-Patent Document 1 may be used if the re-encryption system is based on the cryptographic scheme capable of decrypting ciphertext with the decryption key, when the attribute information set on the decryption key satisfies the decryption condition set on the ciphertext.

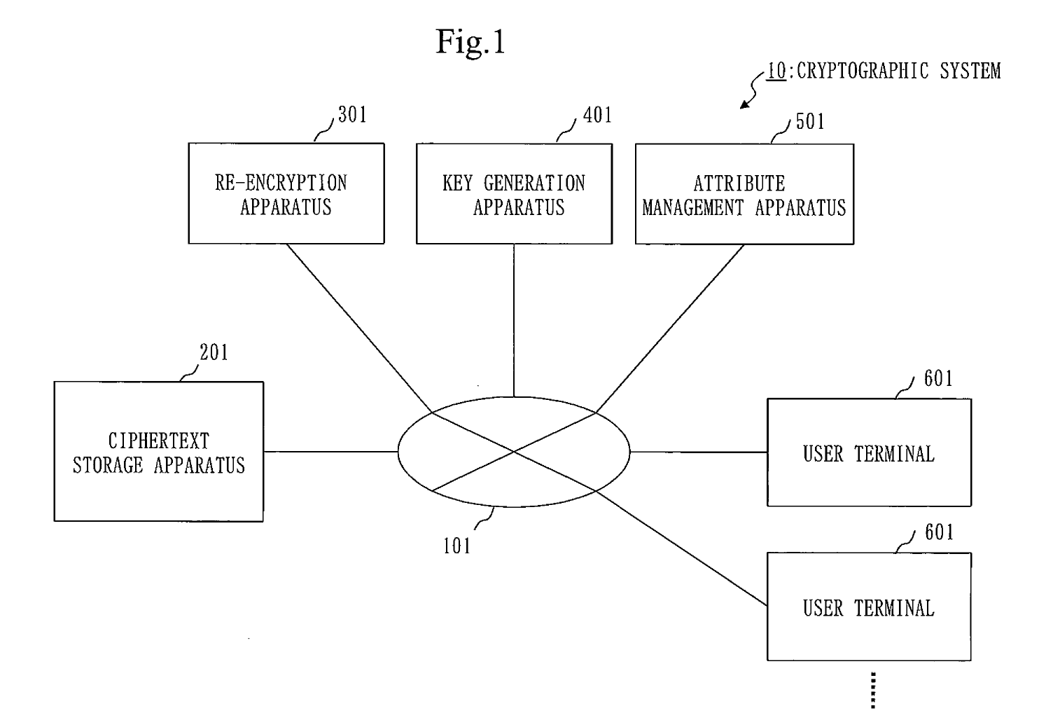

FIG. 1 is a diagram illustrating a configuration of a cryptographic system 10 according to a first embodiment.

The cryptographic system 10 is configured to connect a ciphertext storage apparatus 201, a re-encryption apparatus 301, a key generation apparatus 401, an attribute management apparatus 501, and a plurality of user terminals 601, via a network 101.

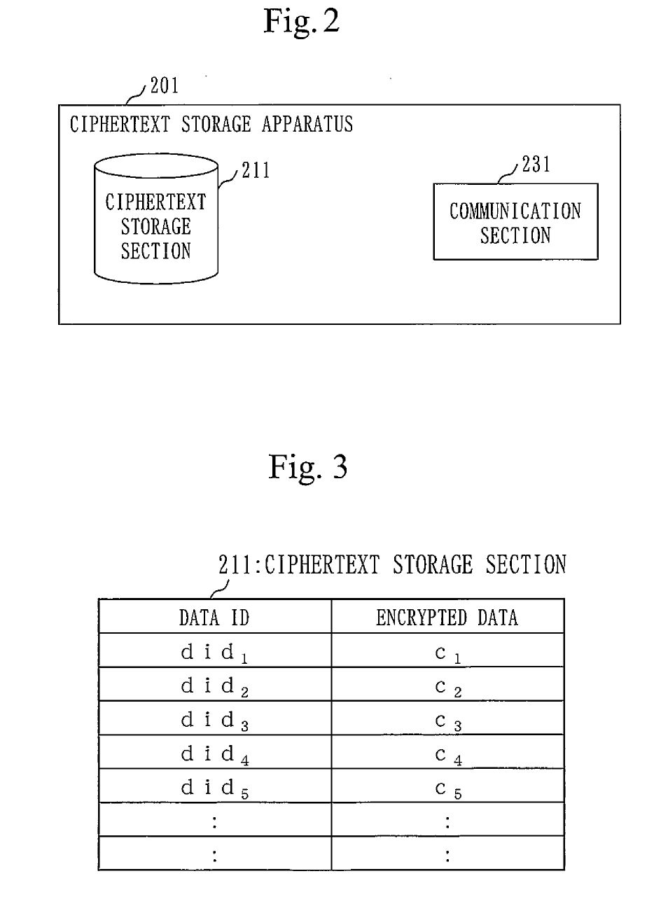

FIG. 2 is a diagram illustrating a configuration of the ciphertext storage apparatus 201 according to the first embodiment.

The ciphertext storage apparatus 201 holds ciphertext and sends/receives ciphertext in response to a request from a user terminal 601. The ciphertext storage apparatus 201 includes a ciphertext storage section 211 and a communication section 231.

The ciphertext storage section 211 is a storage unit to store ciphertext in relation to a corresponding data ID, as shown in FIG. 3. Ciphertext may include an encrypted file of a document, an image or the like; an encrypted character string of a personal name or the like; and an encrypted numerical value of age or the like, as examples. The ciphertext storage section 211 may store two or more pieces or types of ciphertext for one data ID. The ciphertext storage section 211 may also store ciphertext in relation to a search keyword or the like.

The communication section 231 communicates with the user terminals 601 and so forth.

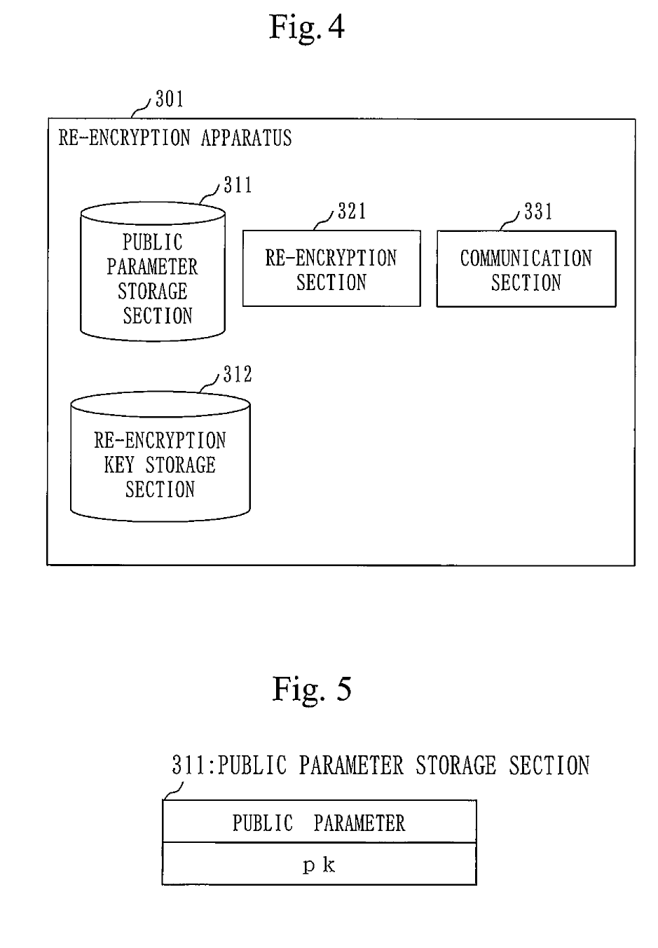

FIG. 4 is a diagram illustrating a configuration of the re-encryption apparatus 301 according to the first embodiment.

The re-encryption apparatus 301 receives ciphertext on which a decryption condition is set, then re-encrypts the received ciphertext for a specific user, and sends it to a user terminal 601. The re-encryption apparatus 301 includes a public parameter storage section 311, a re-encryption key storage section 312, a re-encryption section 321 and a communication section 331.

The public parameter storage section 311 is a storage unit to store a public parameter in functional encryption which is required for re-encryption of data, as shown in FIG. 5.

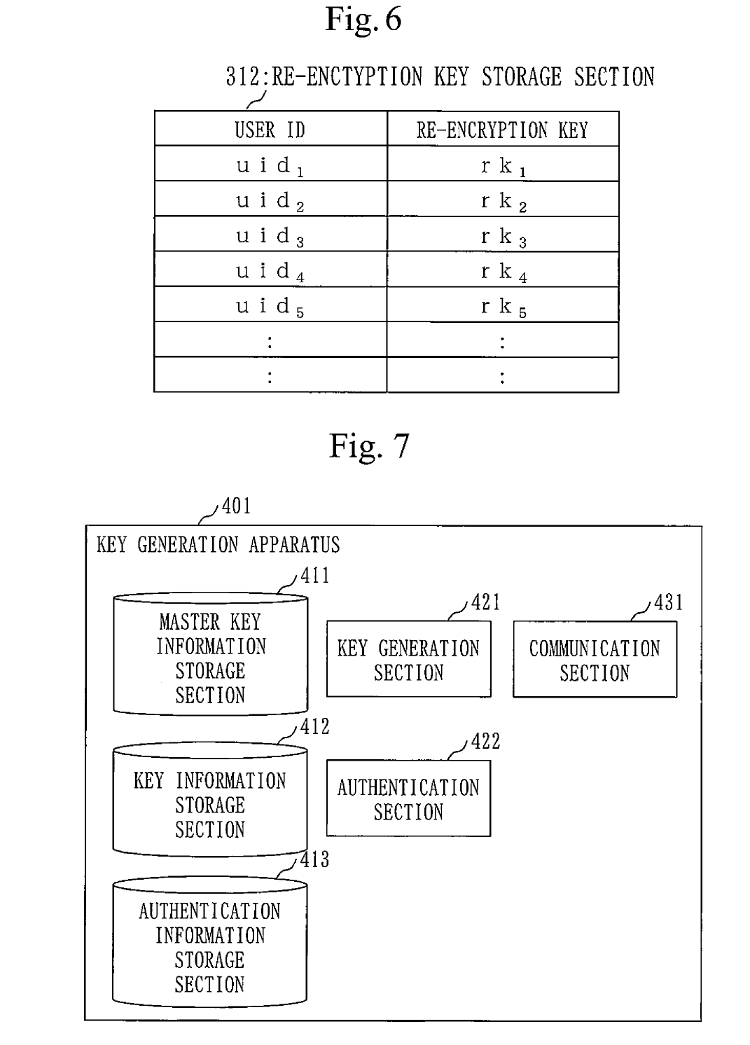

The re-encryption key storage section 312 is a storage unit to store, in relation to a corresponding user ID, a re-encryption key to re-encrypt, for a specific user, ciphertext on which a decryption condition is set, as shown in FIG. 6.

The re-encryption section 321 re-encrypts ciphertext on which a decryption condition is set, with a re-encryption key stored in the re-encryption key storage section 312, and outputs ciphertext for a specific user. Re-encryption is implemented by using an existing cryptographic technology (herein, the cryptographic technology disclosed in Non-Patent Document 1).

The communication section 331 communicates with the attribute management apparatus 501, the user terminals 601, and so forth.

FIG. 7 is a diagram illustrating a configuration of the key generation apparatus 401 according to the first embodiment.

The key generation apparatus 401 generates keys (a public parameter and a private key) in functional encryption which are required for encryption/decryption of data, and a re-encryption key in functional encryption which is required for re-encryption of data. The key generation apparatus 401 includes a master key information storage section 411, a key information storage section 412, an authentication information storage section 413, a key generation section 421, an authentication section 422 and a communication section 431.

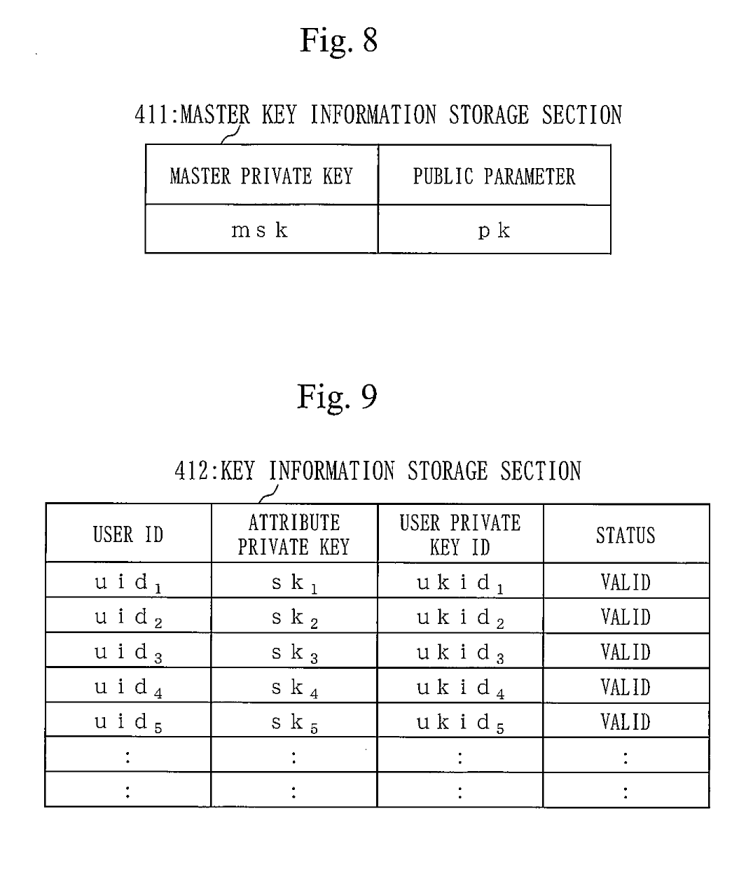

The master key information storage section 411 is a storage unit to store a master private key and a public parameter in functional encryption, as shown in FIG. 8.

The key information storage section 412 is a storage unit to store a private key corresponding to the attribute of each user (hereinafter, referred to as an attribute private key) and the ID (a user private key ID) of a private key to decrypt ciphertext for each user (hereinafter, referred to as a user private key), in relation to a corresponding user ID, as shown in FIG. 9.

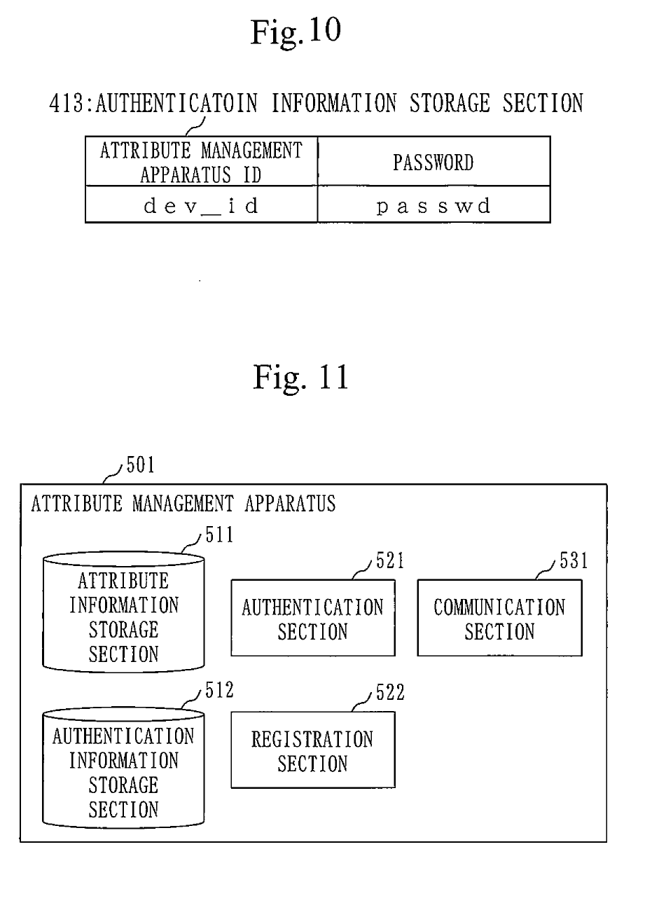

The authentication information storage section 413 is a storage unit to store information required for authentication with the attribute management apparatus 501 (herein, the ID of the attribute management apparatus 501 (an attribute management apparatus ID) and a password), as shown in FIG. 10.

The key generation section 421 generates a key in functional encryption and a re-encryption key. Key generation is implemented by using an existing cryptographic technology (herein, the cryptographic technology disclosed in Non-Patent Document 1).

The authentication section 422 performs authentication with the attribute management apparatus 501. Authentication is implemented by using an existing authentication technology.

The communication section 431 communicates with the attribute management apparatus 501 and so forth.

FIG. 11 is a diagram illustrating a configuration of the attribute management apparatus 501 according to the first embodiment.

The attribute management apparatus 501 manages the attribute of each user, and requests the key generation apparatus 401 to generate a user private key and a re-encryption key based on the attribute managed. The attribute management apparatus 501 includes an attribute information storage section 511, an authentication information storage section 512, an authentication section 521, a registration section 522 and a communication section 531.

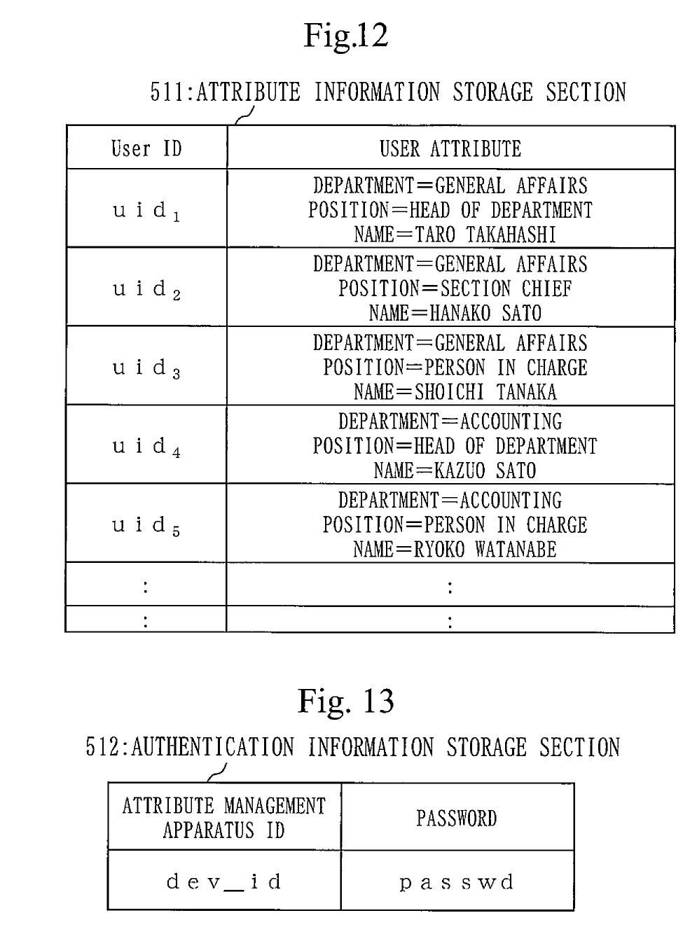

The attribute information storage section 511 is a storage unit to store the attribute of each user, in relation to a corresponding user ID, as shown in FIG. 12.

The authentication information storage section 512 is a storage unit to store information required for authentication with the key generation apparatus 401 (herein, the ID of the attribute management apparatus 501 (an attribute management apparatus ID) and a password), as shown in FIG. 13.

The authentication section 521 performs authentication with the key generation apparatus 401. Authentication is implemented by using an existing authentication technology.

The registration section 522 registers the attribute information of the user. Registration is performed by an administrator operating on an input screen or the like, for example.

The communication section 531 communicates with the re-encryption apparatus 301, the key generation apparatus 401 and the user terminals 601.

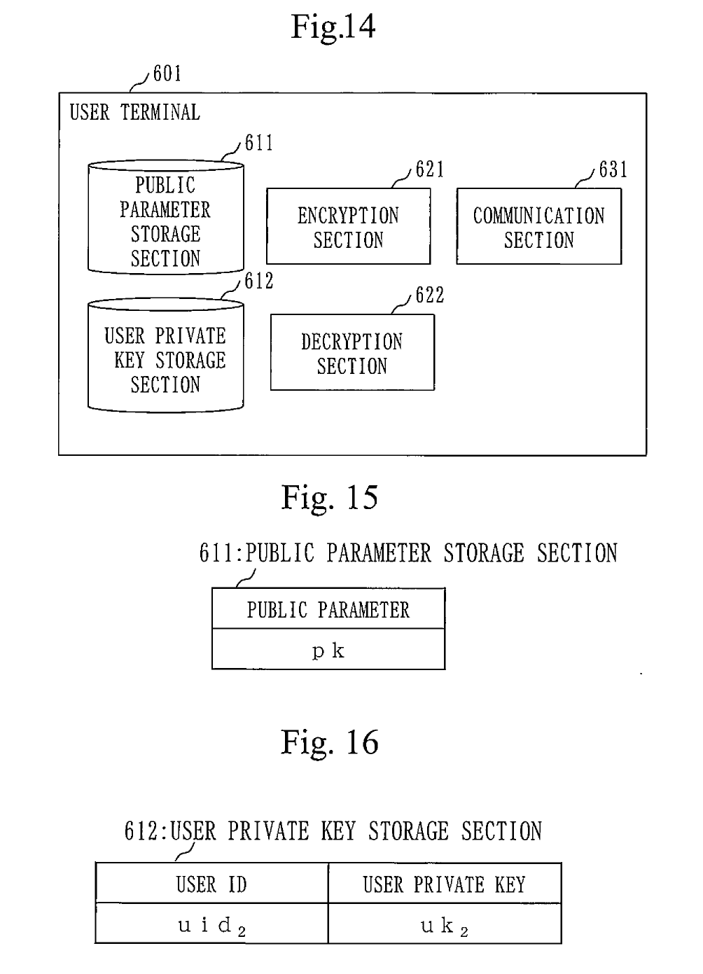

FIG. 14 is a diagram illustrating a configuration of a user terminal 601 according to the first embodiment.

The user terminal 601 stores ciphertext in the ciphertext storage apparatus 201, receives and decrypts the ciphertext from the ciphertext storage apparatus 201, as needed. The user terminal 601 includes a public parameter storage section 611, a user private key storage section 612, an encryption section 621, a decryption section 622 and a communication section 631.

The public parameter storage section 611 is a storage unit to store a public parameter in functional encryption which is required for encryption or decryption of data, as shown in FIG. 15.

The user private key storage section 612 is a storage unit to store the user private key required for decryption of data, in relation to the user ID, as shown in FIG. 16.

The encryption section 621 sets a decryption condition and encrypts data. Encryption is implemented by using an existing cryptographic technology (herein, the cryptographic technology disclosed in Non-Patent Document 1).

The decryption section 622 decrypts the re-ciphertext received from the re-encryption apparatus 301, with the user private key. Decryption is implemented by using an existing cryptographic technology (herein, the cryptographic technology disclosed in Non-Patent Document 1).

The communication section 631 communicates with the ciphertext storage apparatus 201, the re-encryption apparatus 301, the attribute management apparatus 501 and so forth.

An operation of the cryptographic system 10 is discussed. The operation of the cryptographic system 10 generally includes the processes of: (1) Default setting for the whole system, (2) User registration, (3) Data registration, (4) Data acquisition, (5) User private key updating and (6) User attribute updating.

In the following description, the cryptographic technology disclosed in Non-Patent Document 1 is referred to simply as functional encryption.

(1) Default Setting for the Whole System

Default setting for the whole system is a process to provide default information required for the operation of the cryptographic system 10. Default setting for the whole system is performed prior to the start of operation of the cryptographic system 10.

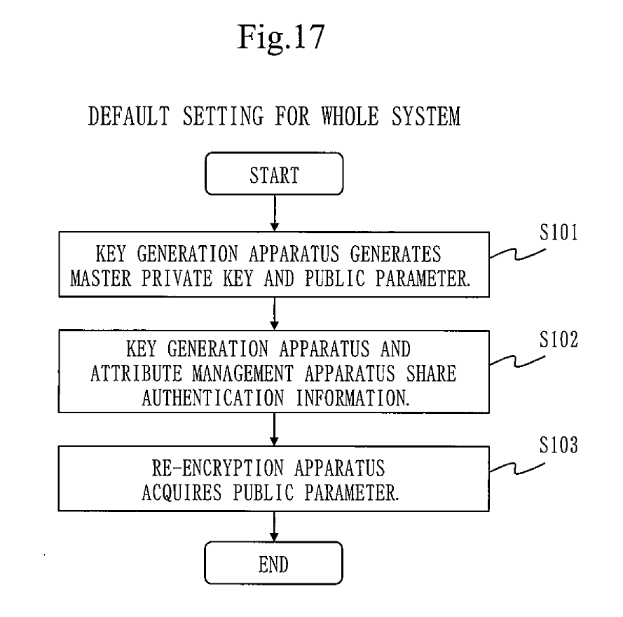

FIG. 17 is a flow chart illustrating a flow of default setting for the whole system.

(S101)

The key generation section 421 of the key generation apparatus 401 performs default setting in functional encryption, generates a master private key and a public parameter, and stores the generated master private key and public parameter in the master key information storage section 411.

As a result, the master key information storage section 411 stores the information shown in FIG. 8.

(S102)

The key generation apparatus 401 and the attribute management apparatus 501 share information required for authentication, and store the information in the authentication information storage section 413 and the authentication information storage section 512. Herein, a set of the attribute management apparatus ID and the password is shared.

As a result, the authentication information storage section 413 stores the information shown in FIG. 10, and the authentication information storage section 512 stores the information shown in FIG. 13.

(S103)

The communication section 531 of the attribute management apparatus 501 acquires a public parameter from the key generation apparatus 401, and sends the public parameter to the re-encryption apparatus 301. The communication section 331 of the re-encryption apparatus 301 receives the public parameter, and stores the public parameter in the public parameter storage section 311.

As a result, the public parameter storage section 311 stores the information shown in FIG. 5.

(2) User Registration

User registration is a process to register a user using the cryptographic system 10. User registration is performed just after “(1) Default setting for the whole system” and at each increase in the number of users using the cryptographic system 10. Herein, a process to register one user is described. If two or more users are to be registered, the process described below needs to be repeated the number of times corresponding to the number of users to be registered. Some examples in the following description, however, indicate that two or more users have been registered.

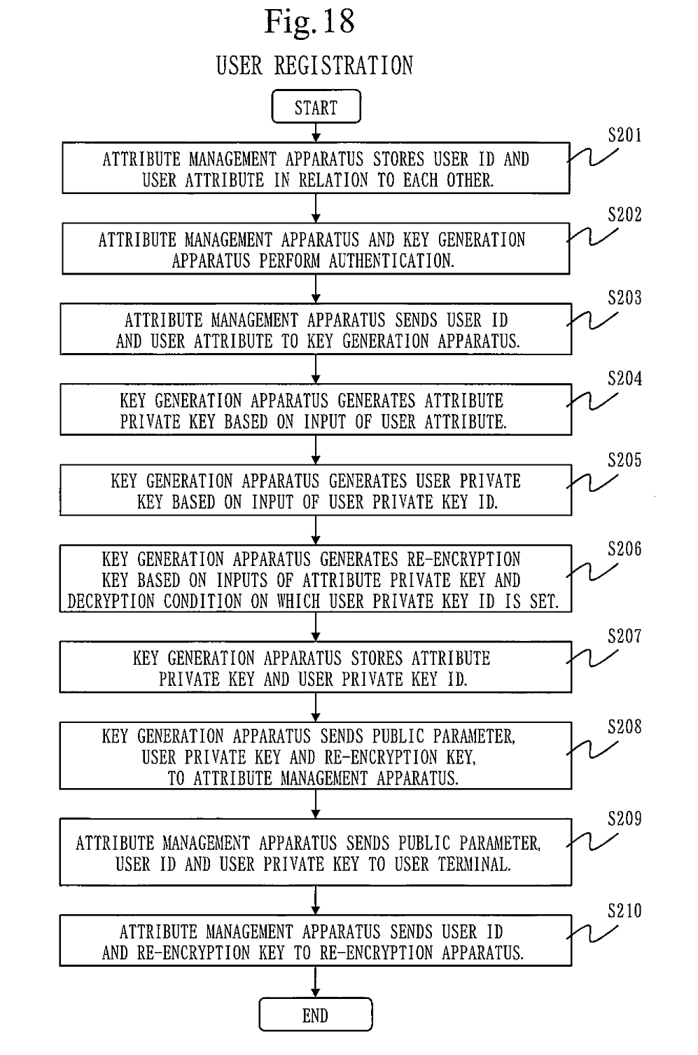

FIG. 18 is a flow chart illustrating a flow of user registration.

(S201)

The registration section 522 of the attribute management apparatus 501 assigns a unique user ID to the user to be registered. The registration section 522 sets a user attribute required for generation of a private key in functional encryption. The registration section 522 then stores the user ID and the user attribute, in relation to each other, in the attribute information storage section 511.

As a result, the attribute information storage section 511 stores the information shown in FIG. 12. FIG. 12 indicates that a number of users have been registered: Referring to FIG. 12, with respect to Hanako Sato who is section chief at the general affairs department, uid₂ is assigned as the user ID and “Department=General affairs, Position=Section chief, Name=Hanako Sato” is set as the user attribute, for example.

(S202)

The authentication section 521 of the attribute management apparatus 501 and the authentication section 422 of the key generation apparatus 401 perform authentication using authentication information stored in the authentication information storage section 512 and the authentication information storage section 413, respectively. Herein, authentication is performed based on the attribute management apparatus ID and a password.

(S203)

When the authentication succeeds, the communication section 531 of the attribute management apparatus 501 sends the user ID and the user attribute of the user to be registered to the key generation apparatus 401, requesting that the key be issued.

Referring to the above example, uid₂ and “Department=General Affairs, Position=Section chief, Name=Hanako Sato” are sent as the user ID and the user attribute.

(S204)

The key generation section 421 of the key generation apparatus 401 performs private key generation in functional encryption, based on inputs of a master private key and a public parameter, stored in the master key information storage section 411, and of the received user attribute. As a result, an attribute private key on which the user attribute (one of the pieces of user attribute information) is set is generated.

Referring to the above example, with respect to Ms. Hanako Sato whose user ID is uid₂, an attribute private key sk₂ is generated based on an input of the user attribute “Department=General Affairs, Position=Section chief, Name=Hanako Sato”.

(S205)

The key generation section 421 of the key generation apparatus 401 generates a unique user secret ID (one of the pieces of key information) in the key information storage section 412. Herein, ukidᵢ is assumed to be generated. The key generation section 421 performs private key generation in functional encryption based on inputs of the master private key, the public parameter and an attribute “user private key ID=ukidᵢ”. As a result, a user private key on which the user private key ID is set is generated.

Referring to the above example, with respect to Ms. Hanako Sato whose user ID is uid₂, ukid₂ is generated as the user private key ID, and then a user private key uk₂ is generated based on an input of an attribute “user private key ID=ukid₂”.

(S206) The key generation section 421 of the key generation apparatus 401 performs re-encryption key generation in functional encryption, based on inputs of the public parameter, the attribute private key and a decryption condition “User private key ID=ukidᵢ” (the other piece of key information). As a result, a re-encryption key is generated.

Referring to the above example, with respect to Ms. Hanako Sato whose user ID is uid₂, a re-encryption key rk₂ is generated based on inputs of the attribute private key sk₂ and the decryption condition “User private key ID=ukid₂”.

More specifically, the re-encryption key generated herein is a key to re-encrypt the ciphertext that can be decrypted with the received attribute private key, into the ciphertext that can be decrypted with the user private key on which the received user private key ID is set.

(S207)

The key generation section 421 of the key generation apparatus 401 relates the user ID, the attribute private key and the user private key ID to one another, sets the status to “Valid”, and stores the user ID, the attribute private key, the user private key ID and the status, in the key information storage section 412.

As a result, the key information storage section 412 stores the information shown in FIG. 9. FIG. 9 indicates that a number of users have been registered.

(S208)

The communication section 431 of the key generation apparatus 401 sends the public parameter, the user private key and the re-encryption key to the attribute management apparatus 501.

With reference to the above example, uk₂ and rk₂ are sent as the user private key and the re-encryption key.

(S209)

The communication section 531 of the attribute management apparatus 501 sends the public parameter, the user ID and the user private key to a user terminal 601 corresponding to the user ID. The communication section 631 of the user terminal 601, upon receipt of the public parameter, the user ID and the user private key, stores the public parameter in the public parameter storage section 611 and stores the user ID and the user private key in the user private key storage section 612.

With reference to the above example, the information is sent to the user terminal 601 corresponding to Ms. Hanako Sato whose user ID is uid₂. As a result, the public parameter storage section 611 of the user terminal 601 corresponding to Ms. Hanako Sato stores the information shown in FIG. 15, and the user private key storage section 612 stores the information shown in FIG. 16.

(S210)

The communication section 531 of the attribute management apparatus 501 sends the user ID and the re-encryption key to the re-encryption apparatus 301. The communication section 331 of the re-encryption apparatus 301, upon receipt of the user ID and the re-encryption key, stores the user ID and the re-encryption key in relation to each other, in the re-encryption key storage section 312.

With reference to the above example, rk₂ is sent as the re-encryption key, and as a result, the re-encryption key storage section 312 stores the information shown in FIG. 6. FIG. 6 indicates that a number of users have been registered.

The point here is to introduce, as the attribute in functional encryption, the virtual attribute “user private key ID” which is not used as the decryption condition by the user terminal 601 for data registration (described in process (3) below in detail), so that the attribute private key and the user private key are used separately within the same framework of functional encryption. This allows a single key generation apparatus 401 along with a single public parameter to implement key issuance and re-encryption.

With reference to the example of FIG. 9, the key information storage section 412 of the key generation apparatus 401 stores the user ID, the attribute private key, the user private key ID and the status. Alternatively, the key information storage section 412 may also store the user attribute, the user private key and the re-encryption key which have been received or generated during processing. It is also possible that the key information storage section 412 does not store the attribute private key, which is re-generated instead based on the user attribute, as needed.

With reference to the attribute management apparatus 501 storing neither the user private key nor the re-encryption key from a security point of view, the public parameter may be stored exclusively. Furthermore, the user private key and the re-encryption key may be sent directly from the key generation apparatus 401, instead of being sent via the attribute management apparatus 501, to the user terminal 601 or the re-encryption apparatus 301.

Further, the user private key storage section 612 of the user terminal 601 may store the user attribute.

(3) Data Registration

Data registration is a process to register data in the ciphertext storage apparatus 201. Data registration is performed each time the user terminal 601 registers data.

In data registration, the user terminal 601, when registering data in the ciphertext storage apparatus 201, sends data encrypted through functional encryption, to the ciphertext storage apparatus 201 so that only the user with authority can access the data. As a result, the data can be kept secret not only from users without authority but also from the ciphertext storage apparatus 201.

In the following description, some examples indicate that a number of pieces of data have been registered.

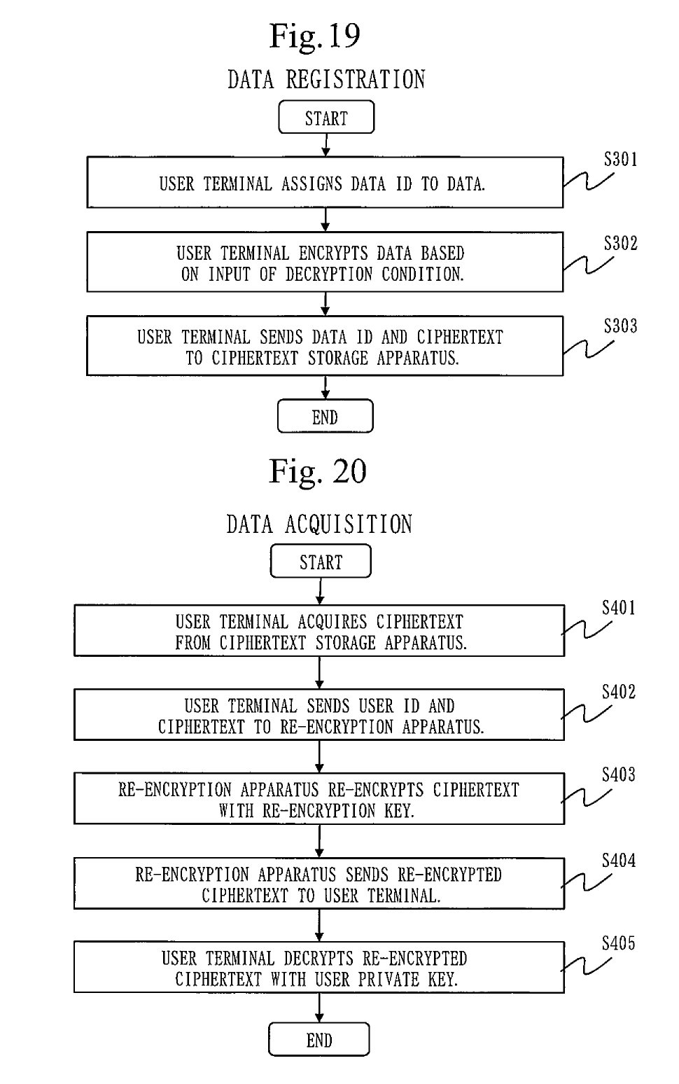

FIG. 19 is a flow chart illustrating a flow of data registration.

(S301)

The encryption section 621 of the user terminal 601 assigns a unique data ID to data to be registered.

(S302)

The encryption section 621 of the user terminal 601 performs encryption in functional encryption, based on inputs of the public parameter stored in the public parameter storage section 611, data to be registered, and the decryption condition specifying the user attribute which can be decrypted (the other piece of user attribute information). As a result, ciphertext obtained by encrypting the data is generated.

Examples of the decryption condition may include: “Department General affairs” (decryption can be done only by the users belonging to the general affairs department), “Department=General affairs AND Position=Head of department” (decryption can be done only by the head of the general affairs department), “Department=General affairs OR Position=Head of department” (decryption can be done only by the users belonging to the general affairs department and by the heads of departments). According to the system of functional encryption for use, not only AND and OR conditions, but also a NOT condition, like “NOT (Department=General affairs) AND Position=Head of department” (decryption can be done only by the heads of departments except the head of the general affairs department), may be used.

(S303)

The communication section 631 of the user terminal 601 sends the data ID and the ciphertext to the ciphertext storage apparatus 201. The ciphertext storage apparatus 201, upon receipt of the data ID and the ciphertext, stores the data ID and the ciphertext in relation to each other, in the ciphertext storage section 211.

As a result, the ciphertext storage section 211 stores the information shown in FIG. 3. FIG. 3 indicates that a number of data pieces have been registered.

With reference to data encryption, data may be encrypted through a different cryptographic scheme (e.g., a common key cryptographic scheme such as AES: Advanced Encryption Standard), rather than encrypted directly through functional encryption, and then the key used for encryption may be encrypted through functional encryption. In this case, both the functional encryption and the different cryptographic scheme are to be used for decryption.

With reference to the example of FIG. 3 where the ciphertext storage section 211 of the ciphertext storage apparatus 201 stores data IDs and ciphertext, the ciphertext storage apparatus 201 may also receive the decryption condition from the user terminal 601, and store the decryption condition in the ciphertext storage section 211. The decryption condition may be used as auxiliary information for the user terminal 601 to retrieve necessary information from the ciphertext storage apparatus 201.

(4) Data Acquisition

Data acquisition is a process to read ciphertext from the ciphertext storage apparatus 201 by the user terminal 601. Data acquisition is performed each time the user terminal 601 reads ciphertext from the ciphertext storage apparatus 201.

The cryptographic system 10 is designed so that ciphertext stored in the ciphertext storage apparatus 201 cannot be decrypted by the user terminal 601 alone, to implement user or key invalidation management. In the cryptographic system 10, ciphertext acquired from the ciphertext storage apparatus 201 is sent to the re-encryption apparatus 301 to be re-encrypted for individual users.

FIG. 20 is a flow chart illustrating a flow of data acquisition.

(S401)

The communication section 631 of the user terminal 601 sends the data ID of data to be acquired to the ciphertext storage apparatus 201. The ciphertext storage apparatus 201, upon receipt of the data ID, acquires the ciphertext related to the data ID from the ciphertext storage section 211, and sends the ciphertext to the user terminal 601.

Now, since the user attribute is specified on the ciphertext as the decryption condition, the attribute private key on which the user attribute satisfying the decryption condition is set is required to decrypt the ciphertext. It is the user private key that is stored in the user private key storage section 612 of the user terminal 601. Therefore, the user terminal 601 cannot decrypt the ciphertext.

For example, it is assumed that ciphertext c₁ has been encrypted with the decryption condition “Department=General affairs”, and that Ms. Hanako Sato whose user ID is uid₂, in FIG. 12, acquires the ciphertext c₁. Ms. Hanako Sato who belongs to the general affairs department is supposed to be able to decrypt the ciphertext c₁. However, the user private key uk₂ of Ms. Hanako Sato has been generated based on an input of the attribute “user private key ID=ukid₂”, and therefore the attribute set on the user private key uk₂ does not correspond to the decryption condition. At this rate, decryption cannot be done.

(S402)

The communication section 631 of the user terminal 601 sends the user ID and the ciphertext to the re-encryption apparatus 301, requesting that the data be re-encrypted. The re-encryption apparatus 301, upon receipt of the user ID and the ciphertext, acquires the re-encryption key related to the user ID from the re-encryption key storage section 312.

With reference to the above example, the communication section 631 receives uid₂ as the user ID, and acquires the re-encryption key rk₂ related to uid₂. As discussed above, rk₂ is the re-encryption key to re-encrypt the ciphertext that can be decrypted with the attribute private key sk₂ generated based on the attribute “Department=General affairs, Position=Section chief, Name=Hanako Sato” to have the decryption condition “user private key ID=ukid₂”.

(S403)

The re-encryption section 321 of the re-encryption apparatus 301 performs re-encryption in functional encryption based on inputs of the public parameter stored in the public parameter storage section 311, the re-encryption key acquired from the re-encryption key storage section 312 and the received ciphertext. As a result, the ciphertext (re-ciphertext) that can be decrypted with the user private key is generated.

With reference to the above example, the ciphertext c₁ is re-encrypted with the re-encryption key rk₂ to generate ciphertext C₁ with the decryption condition “User private key ID=ukid₂”.

(S404)

The communication section 331 of the re-encryption apparatus 301 sends the ciphertext generated through re-encryption to the user terminal 601. In case that the re-encryption fails, however, the failure is sent to the user terminal 601.

(S405)

The decryption section 622 of the user terminal 601, upon receipt of the ciphertext, performs decryption in functional encryption based on inputs of the public parameter stored in the public parameter storage section 611, the user private key stored in the user private key storage section 612 and the received ciphertext. As a result, the data corresponding to the initially specified data ID can be obtained.

With reference to the above example, the user terminal 601 receives the ciphertext C₁, which is then decrypted with the user private key uk₂. As a result, data d₁ can be obtained because the attribute “user private key ID ukid₂” and the decryption condition “user private key ID=ukid₂” match.

As discussed above, the user terminal 601 with authority can access data in the ciphertext storage apparatus 201 (within the scope of its own authority).

(5) User Private Key Updating

User private key updating is a process to re-issue a user private key for the user whose user private key is lost, leaked or the like. User private key updating is performed for re-issuing a user private key.

Re-issuing of the user private key allows the user to keep using the cryptographic system 10. Further, however, leakage of data stored in the ciphertext storage apparatus 201 via a lost or leaked user private key needs to be prevented. This may be prevented by updating the re-encryption key stored in the re-encryption apparatus 301 in user private key updating.

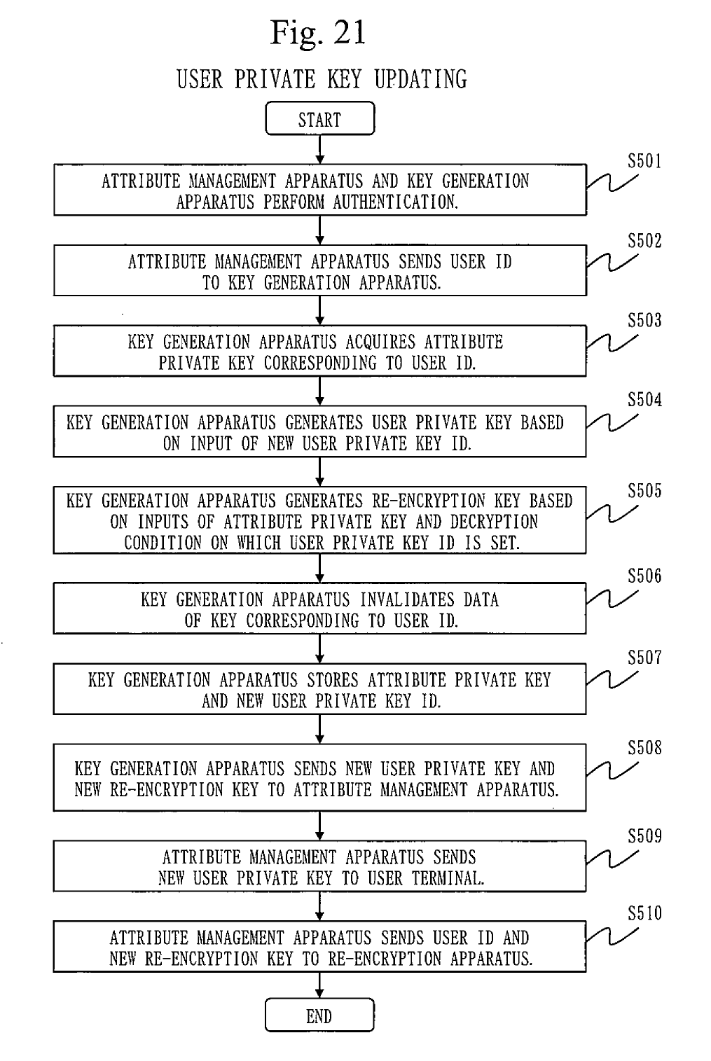

FIG. 21 is a flow chart illustrating a flow of user private key updating.

(S501)

The authentication section 521 of the attribute management apparatus 501 and the authentication section 422 of the key generation apparatus 401 perform authentication based on the authentication information stored in the authentication information storage section 512 and the authentication information storage section 413, respectively. Herein, authentication is performed based on the attribute management apparatus ID and the password.

(S502)

Once the authentication succeeds, the communication section 531 of the attribute management apparatus 501 sends to the key generation apparatus 401 the user ID of the user whose user private key is to be updated, requesting that the key be re-issued.

To update the user private key uk₂ of Ms. Hanako Sato whose user ID is uid₂, described as an example in “(2) User registration”, uid₂ is sent as the user ID.

(S503)

The key generation section 421 of the key generation apparatus 401 acquires the attribute private key related to the user ID from the key information storage section 412.

With reference to the above example, when the key information storage section 412 stores the information shown in FIG. 9, the attribute private key sk₂ is acquired.

(S504)

The key generation section 421 of the key generation apparatus 401 generates a new unique user private key ID in the key information storage section 412. Herein, it is assumed that ukidᵢ is generated. The key generation section 421 performs private key generation in functional encryption based on inputs of the master private key and the public parameter stored in the master key information storage section 411, and of the attribute “user private key ID=ukidᵢ”. As a result, a user private key on which the newly generated user private key ID is set is generated.

With reference to the above example, ukid₁₀₂ is generated as the user private key ID, and then a user private key uk₁₀₂ is generated based on an input of the attribute “user private key ID=ukid₁₀₂”.

(S505)

The key generation section 421 of the key generation apparatus 401 performs re-encryption key generation in functional encryption based on inputs of the public parameter, the attribute private key, and the decryption condition “user private key ID=ukidᵢ” based on the new user private key ID generated at S503. As a result, the re-encryption key is generated.

Referring to the above example, with respect to Ms. Hanako Sato whose user ID is uid₂, a re-encryption key rk₁₀₂ is generated based on inputs of the attribute private key sk₂ and the decryption condition “user private key ID=ukid₁₀₂”.

(S506)

The key generation section 421 of the key generation apparatus 401 searches the key information storage section 412 for a record related to the user ID, and updates the status of the record by “Invalid”.

(S507)

The key generation section 421 of the key generation apparatus 401 relates the user ID, the attribute private key, and the newly generated user private key ID to one another, sets the status to “Valid”, and stores in the key information storage section 412 the related user ID, attribute private key, and newly generated user private key ID and the set status.

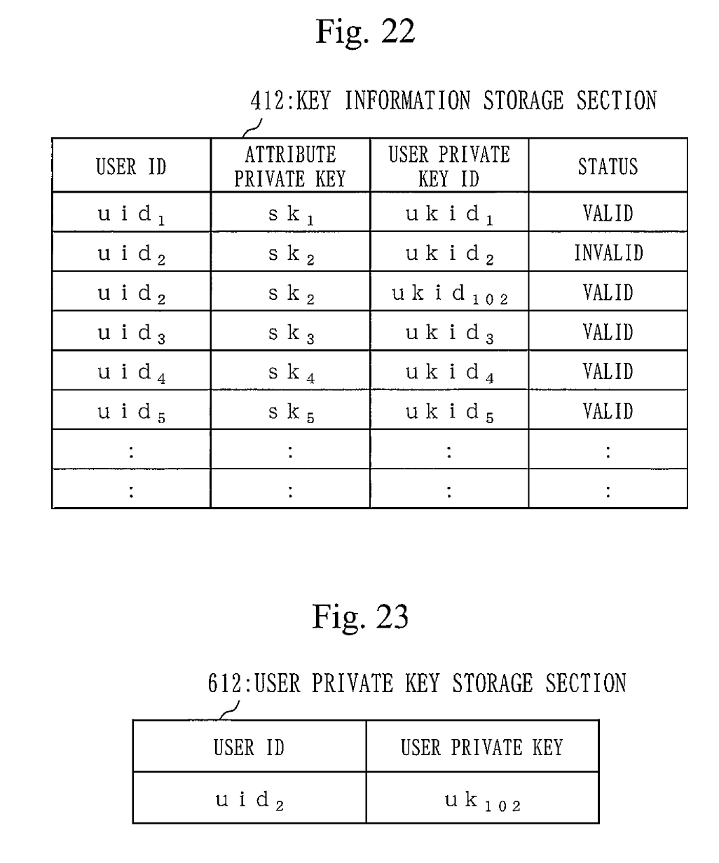

As a result, the key information storage section 412 is updated to store the information shown in FIG. 22 from the previously stored information shown in FIG. 9.

(S508)

The communication section 431 of the key generation apparatus 401 sends the newly generated user private key, and the newly generated re-encryption key to the attribute management apparatus 501.

With reference to the above example, uk₁₀₂ and rk₁₀₂ are sent as the user private key and the re-encryption key.

(S509)

The communication section 531 of the attribute management apparatus 501 sends the user private key to the user terminal 601 corresponding to the user ID. The communication section 631 of the user terminal 601, upon receipt of the user private key, updates the user private key stored in the user private key storage section 612 by the received user private key.

With reference to the above example, the user private key storage section 612 of the user terminal 601 corresponding to Ms. Hanako Sato whose user ID is uid₂ is updated to store information shown in FIG. 23 from the previously stored information shown in FIG. 16.

(S510)

The communication section 531 of the attribute management apparatus 501 sends the user ID and the newly generated re-encryption key to the re-encryption apparatus 301. The communication section 331 of the re-encryption apparatus 301, upon receipt of the user ID and the newly generated re-encryption key, searches the re-encryption key storage section 312 for a record related to the user ID, and updates the re-encryption key of the record by the received re-encryption key.

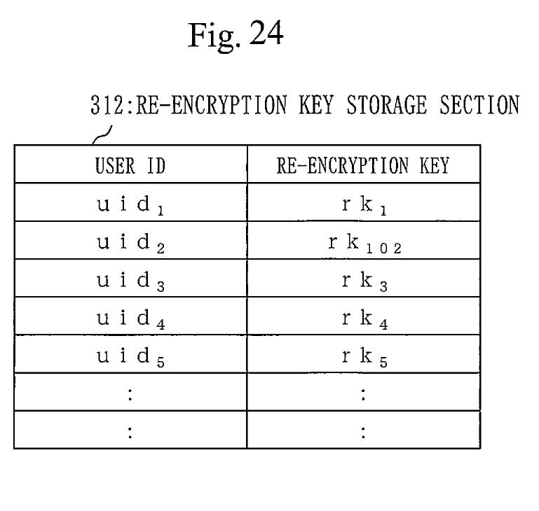

With reference to the above example, the re-encryption key storage section 312 is updated to store information shown in FIG. 24 from the previously stored information shown in FIG. 6.

As discussed above, when the user private key is updated, the re-encryption key is also updated along with the user private key. As a result, the ciphertext that has been re-encrypted with the updated re-encryption key can be decrypted with the updated user private key. Therefore, the user terminal 601 whose user private key has been reissued is allowed to keep accessing previous data which had been accessible before the processing of user private key updating.

On the other hand, the ciphertext that has been re-encrypted with the updated re-encryption key cannot be decrypted with the previous user private key which has not been updated. Therefore, data stored in the ciphertext storage apparatus 201 cannot be accessed with the previous user private key any more.

Thus, the processing described herein results in achievement of invalidation in response to loss or leakage of the user private key.

In the updating process discussed here, the user private key is invalidated and reissued. However, at retirement of the user, or the like, the user private key may be invalidated but not re-issued. In this case, all that is needed is to delete the re-encryption key stored in the re-encryption apparatus 301.

(6) User Attribute Updating

User attribute updating is a process performed so that a user whose attribute (e.g., Department or Position) has been changed, by personnel transfer within a company, or the like, can access data according to a new attribute.

For example, if Ms. Hanako Sato whose user ID is uid₂, described as an example in “(2) User registration”, has been transferred from the general affairs department to the accounting department, data addressed to the accounting department needs to be accessed by Mr. Hanako Sato. Additionally, it may be desirable that data addressed to the general affairs department should not be accessed any more after the transfer (in some cases, however, it may be desirable that continued access to data addressed to the general affairs department should be allowed). Such desires are satisfied through updating of the re-encryption key stored in the re-encryption apparatus 301 in the process of user attribute updating.

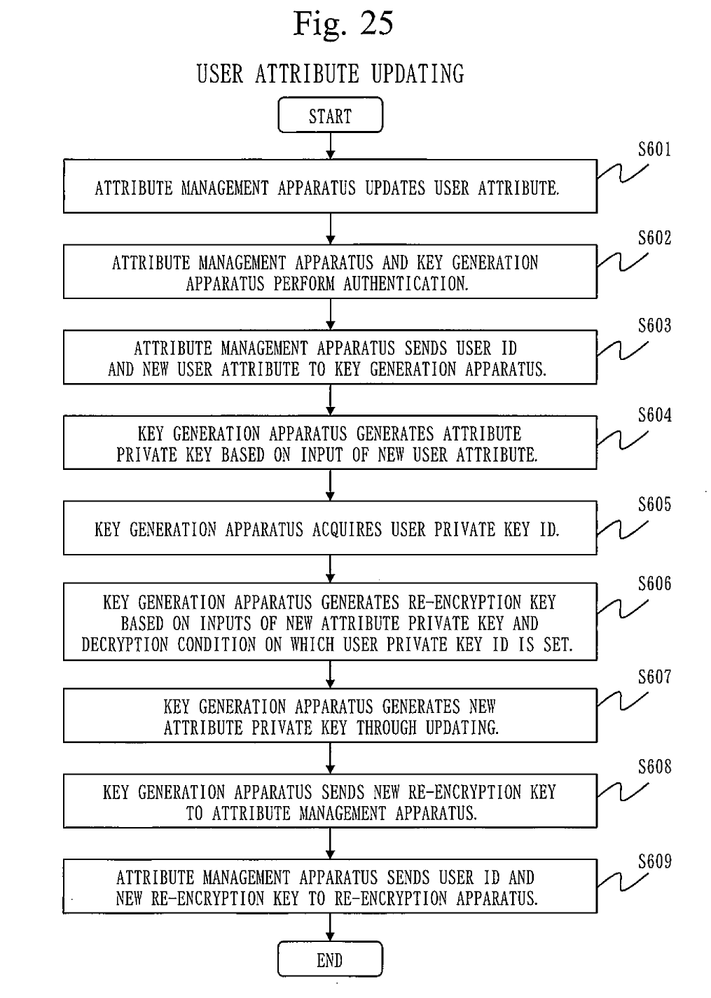

FIG. 25 is a flow chart illustrating a flow of user attribute updating.

(S601)

The registration section 522 of the attribute management apparatus 501 updates the user attribute stored in the attribute information storage section 511 of the user whose attribute is to be updated.

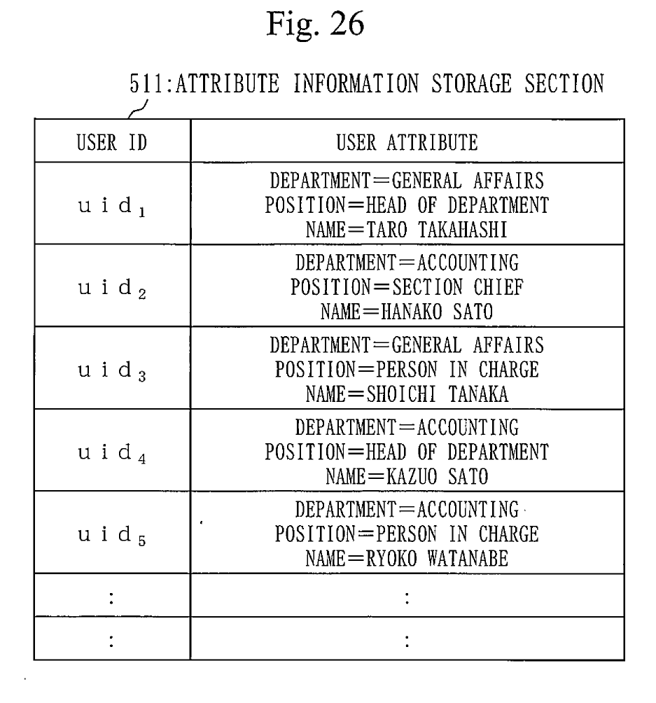

With reference to the above example, the attribute information storage section 511 is updated to store information shown in FIG. 26 from the previously stored information shown in FIG. 12.

(S602)

The authentication section 521 of the attribute management apparatus 501 and the authentication section 422 of the key generation apparatus 401 perform authentication using the authentication information stored in the authentication information storage section 512 and the authentication information storage section 413, respectively. Herein, authentication is performed based on the attribute management apparatus ID and the password.

(S603)

The communication section 531 of the attribute management apparatus 501 sends to the key generation apparatus 401 the user ID and a new user attribute of the user whose user attribute is to be updated, requesting that the key be re-issued.

With reference to the above example, uid₂ and “Department=Accounting, Position=Section chief, Name=Hanako Sato” are sent as the user ID and a new user attribute.

(S604)

The key generation section 421 of the key generation apparatus 401 performs private key generation in functional encryption based on inputs of the master private key and the public parameter stored in the master key information storage section 411 and of the received new user attribute. As a result, an attribute private key on which the new user attribute is set is generated.

Referring to the above example, with respect to Ms. Hanako Sato whose user ID is uid₂, a new attribute private key sk₂₀₂ is generated based on an input of the new user attribute “Department=Accounting, Position=Section chief, Name=Hanako Sato”.

(S605)

The key generation section 421 of the key generation apparatus 401 acquires from the key information storage section 412 the user private key ID related to the user ID. More specifically, if there are two or more records related to the user ID, the key generation section 421 acquires the user private key ID from the record in which the status is “Valid”. Herein, it is assumed that ukidᵢ is acquired.

Referring to the above example, with respect to Ms. Hanako Sato whose user ID is uid₂, ukid₂ is acquired as the user private key ID, based on the information shown in FIG. 9.

(S606)

The key generation section 421 of the key generation apparatus 401 performs re-encryption key generation in functional encryption based on inputs of the public parameter, the new attribute private key, and the decryption condition “User private key ID=ukidᵢ” based on the user private key ID acquired at S605. As a result, the re-encryption key is generated.

Referring to the above example, with respect to Ms. Hanako Sato whose user ID is uid₂, a re-encryption key rk₂₀₂ is generated based on inputs of the new attribute private key sk₂₀₂ and the decryption condition “User private key ID=ukid₂”.

(S607)

The communication section 431 of the key generation apparatus 401 updates the attribute private key of the record in which the user private key ID stored in the key information storage section 412 is ukidᵢ, by the new attribute private key.

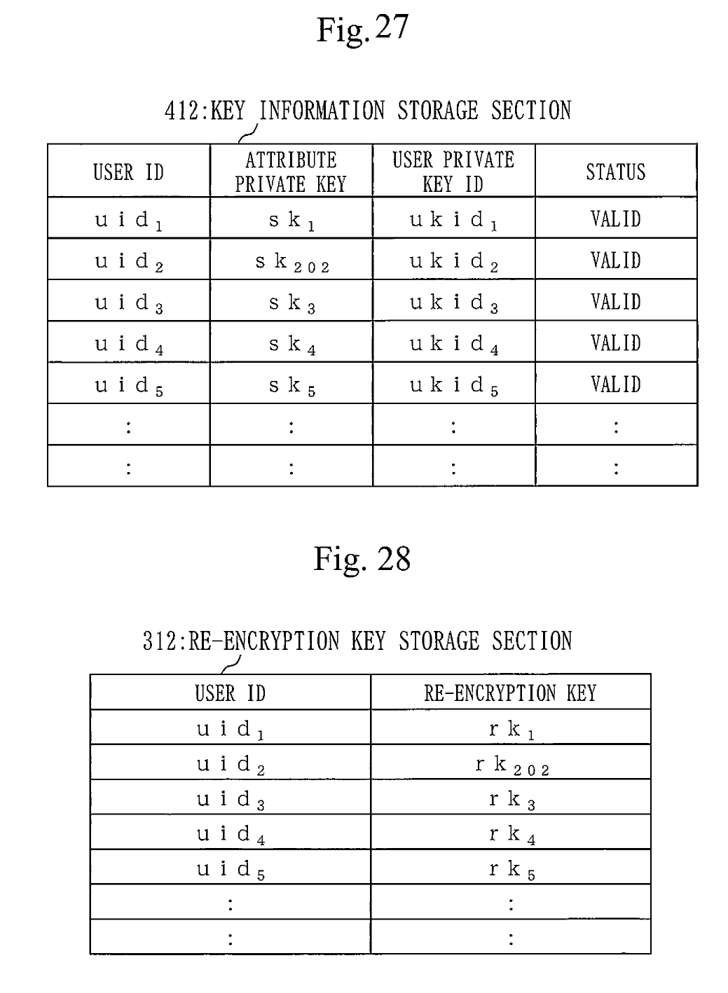

As a result, the key information storage section 412 is updated to store information shown in FIG. 27 from the previously stored information shown in FIG. 9.

(S608)

The communication section 431 of the key generation apparatus 401 sends the newly generated re-encryption key to the attribute management apparatus 501.

With reference to the above example, rk₂₀₂ is sent as the re-encryption key.

(S609)

The communication section 531 of the attribute management apparatus 501 sends the user ID, and the newly generated re-encryption key to the re-encryption apparatus 301. The communication section 331 of the re-encryption apparatus 301, upon receipt of the user ID and the newly generated re-encryption key, searches the re-encryption key storage section 312 for a record related to the user ID, and updates the re-encryption key of the record by the received re-encryption key.

With reference to the above example, the re-encryption key storage section 312 is updated to store information shown in FIG. 28 from the previously stored information shown in FIG. 6.

As discussed above, when the user attribute has been changed, the attribute private key is updated, along with which the re-encryption key is also updated. Therefore, the ciphertext that can be re-encrypted with the updated re-encryption key is the ciphertext accessible with the updated user attribute. Thus, the user terminal 601 of the user whose user attribute has been changed can access data according to the new attribute.

Ciphertext accessible only with the previous attribute (not accessible with the updated user attribute) cannot be re-encrypted with the updated re-encryption key. Therefore, data accessible only with the previous attribute cannot be accessed any more.

Thus, the processing described herein results in achievement of invalidation in response to change in the user attribute.

As discussed above, the cryptographic system 10 of the first embodiment implements the system, through processes (1) to (6), in which the user terminal 601 acquires ciphertext stored in the ciphertext storage apparatus 201, as needed, to only allow the user with authority to decrypt/access data.

With further reference to the cryptographic system 10 of the first embodiment, invalidation in response to loss/leakage of the user private key or change in the user attribute may be implemented by updating the re-encryption key stored in the re-encryption apparatus 301, without updating the ciphertext stored in the ciphertext storage apparatus 201, as discussed in the processes (5) and (6). Thus, an efficient operation may be achieved even in an environment where invalidation is often needed in a large-scale company, or the like,

With further reference to the cryptographic system 10 of the first embodiment, the re-encryption apparatus 301 is allowed to hold one re-encryption key for one user. Therefore, the re-encryption key updating load in invalidation is reduced. In addition, the cryptographic system 10 of the first embodiment is allowed to use flexible access control in functional encryption.

Further, the cryptographic system 10 of the first embodiment is configured so that the ciphertext storage apparatus 201 and the re-encryption apparatus 301 are separated from each other. This prevents an invalidated user (or an attacker obtaining an invalidated user private key) in collusion with the ciphertext storage apparatus 201, from decrypting the ciphertext stored in the ciphertext storage apparatus 201.

Further, in the example described in the above description, the cryptographic system 10 is used by a single company provided with the attribute management apparatus 501 and the user terminal 601. Alternatively, the cryptographic system 10 may be used by two or more companies sharing all or part of the ciphertext storage apparatus 201, the re-encryption apparatus 301 and the key generation apparatus 401. In this case, each apparatus of the cryptographic system 10 needs to manage company IDs uniquely identifying the individual companies, additionally.

Further, the above description (except for some portions thereof) does not mention anything about the authentication of each apparatus or encryption of a communication path, which may be performed, where necessary. In doing so, an existing authentication technology using the password or PKI (public key infrastructure) or an existing cryptographic technology such as SSL (Secure Sockets Layer) communications may be employed.

With reference to “(4) Data acquisition” in the above discussion, the ciphertext storage apparatus 201 sends the ciphertext that is related to the data ID unconditionally to the user terminal 601.

Alternatively, the ciphertext storage section 211 may store the decryption condition of each ciphertext, and then the user terminal 601 may send the user attribute along with the data ID. Then, the ciphertext storage apparatus 201 may determine whether or not the ciphertext can be decrypted, based on the decryption condition and the user attribute, and send only the ciphertext that can be decrypted to the user terminal 601. However, it is to be noted that extra information, such as the decryption condition and the user attribute, will be disclosed to the ciphertext storage apparatus 201, in this case.

With further reference to “(4) Data acquisition” in the above discussion, ciphertext is sent to the re-encryption apparatus 301 via the user terminal 601 for re-encryption performed by the re-encryption apparatus 301.

Alternatively, ciphertext may be sent directly to the re-encryption apparatus 301, not via the user terminal 601, from the ciphertext storage apparatus 201. Further, in this case, the ciphertext storage apparatus 201 and the re-encryption apparatus 301 may be unified into a single apparatus, to enhance efficiency. It is to be noted, however, that the unification of those apparatuses allows an invalidated user, in collusion with the ciphertext storage apparatus 201 (and the re-encryption apparatus 301), to conduct an unauthorized decryption of the ciphertext stored in the ciphertext storage apparatus 201.

Alternatively, the attribute management apparatus 501 and the re-encryption apparatus 301 may be unified into a single apparatus to improve efficiency. It is also possible that efficiency may be enhanced by unifying the attribute management apparatus 501 and the key generation apparatus 401 into a single apparatus.

Further, in the above discussion, re-encryption is performed from functional encryption to the same functional encryption (including the public parameter), for easy operation.

Alternatively, re-encryption may be performed from functional encryption to functional encryption of a different type or to encryption other than functional encryption. For example, re-encryption may be performed from functional encryption to ID based encryption. In this case, the key generation apparatus 401 is provided with two kinds of key generation functions (or two key generation apparatuses 401 are to be provided).

Further, in the above discussion, the user terminal 601 is provided with both functions of data registration and data acquisition.

Alternatively, a user apparatus dedicated to data registration and a user apparatus dedicated to data acquisition may be provided, separately. The user apparatus dedicated to data registration does not need the user private key storage section 612.

Further, in the above discussion, the user private key storage section 612 of the user terminal 601 stores the user private key. Alternatively, the user private key may be stored in an external device (e.g., an IC card), and acquired by the user terminal 601 from the external device, as needed. It is also possible that the external device is provided with an encryption section and a decryption section so that encryption and decryption based on the user private key are performed on the external device side.

Further, in the above discussion, “ciphertext-policy based functional encryption” is employed as functional encryption. As aforementioned, however, “key-policy based functional encryption” may be employed, as well.

For example, in key-policy based functional encryption, an attribute “Department=General affairs, Year of creation=2012” may be set on ciphertext and a policy (decryption condition) “(Department=General affairs AND Year of creation=2012) OR (Department=Accounting AND Year of creation=2013)” may be set on the private key to decrypt the ciphertext. With this example, “Data created by General affairs department in 2012” and “Data created by Accounting department in 2013” can be decrypted with this private key. Thus, more flexible access control may be achieved in response to a change in the department to which the user belongs, such as to allow the user to access exclusively to documents corresponding to the time of user's presence at the department.

It depends on the intended purpose of the data management system, the organization structure of the company concerned, or the like to determine which of ciphertext-policy based attribute based encryption and key-policy based attribute based encryption is appropriate for use.

Further, “Unified-policy based functional encryption” unifying “ciphertext-policy based functional encryption” and “key-policy based functional encryption” may also be employed. In “Unified-policy based functional encryption”, attribute 1 and policy 2 are set on ciphertext, and policy 1 corresponding to attribute 1, and attribute 2 corresponding to policy 2 are set on the decryption key. This allows the advantages of both “ciphertext-policy based functional encryption” and “key-policy based functional encryption” to be used.

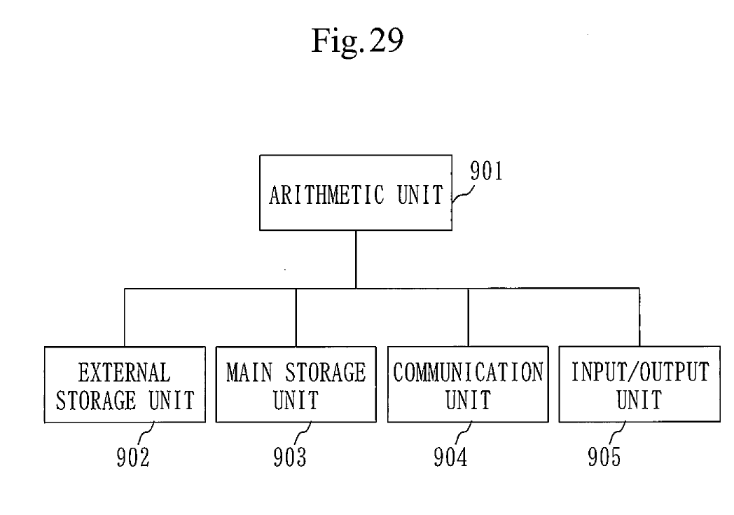

FIG. 29 illustrates an example of the hardware configuration of any one of the ciphertext storage apparatus 201, the re-encryption apparatus 301, the key generation apparatus 401, the attribute management apparatus 501 and the user terminal 601 discussed in the first embodiment.

The ciphertext storage apparatus 201, the re-encryption apparatus 301, the key generation apparatus 401, the attribute management apparatus 501 and the user terminal 601 are computers. Each element of any one of the ciphertext storage apparatus 201, the re-encryption apparatus 301, the key generation apparatus 401, the attribute management apparatus 501 and the user terminal 601 may be achieved by a program.

A hardware configuration of any one of the ciphertext storage apparatus 201, the re-encryption apparatus 301, the key generation apparatus 401, the attribute management apparatus 501 and the user terminal 601, may be described as follows: an arithmetic unit 901, an external storage unit 902, a main storage unit 903, a communication unit 904 and an input/output unit 905 are connected via a bus.

The arithmetic unit 901 is a CPU (Central Processing Unit) for executing programs, or the like. The external storage unit 902 is a ROM (Read Only Memory), a flash memory, a hard disk drive or the like, for example. The main storage unit 903 is a RAM (Random Access Memory) or the like, for example. The communication unit 904 is a communication board or the like, for example. The input/output unit 905 is a mouse, a keyboard, a display unit or the like, for example.

Programs are usually stored in the external storage unit 902, and then loaded to the main storage unit 903 to be sequentially read and executed by the arithmetic unit 901.

Programs implement functions described as the communication section 231, the re-encryption section 321, the communication section 331, the key generation section 421, the authentication section 422, the communication section 431, the authentication section 521, the registration section 522, the communication section 531, the encryption section 621, the decryption section 622 and the communication section 631.

The external storage unit 902 also stores an operating system (OS). At least part of the OS is loaded to the main storage unit 903. The arithmetic unit 901 executes the programs while executing the OS.

Information, data, signal values and variable values which are described as being stored in the ciphertext storage section 211, the public parameter storage section 311, the re-encryption key storage section 312, the master key information storage section 411, the key information storage section 412, the authentication information storage section 413, the attribute information storage section 511, the authentication information storage section 512, the public parameter storage section 611 and the user private key storage section 612, in the description of the first embodiment, are stored in the main storage unit 903, as files.

It is to be noted that the FIG. 29 configuration is only an example of the hardware configuration of any one of the ciphertext storage apparatus 201, the re-encryption apparatus 301, the key generation apparatus 401, the attribute management apparatus 501 and the user terminal 601. The hardware configuration of any one of the ciphertext storage apparatus 201, the re-encryption apparatus 301, the key generation apparatus 401, the attribute management apparatus 501 and the user terminal 601 is not limited to the FIG. 29 configuration. Another configuration may be employed.

### REFERENCE SIGNS LIST

10 cryptographic system
101 network
201 ciphertext storage apparatus
211 ciphertext storage section
231 communication section
301 re-encryption apparatus
311 public parameter storage section
312 re-encryption key storage section
321 re-encryption section
331 communication section
401 key generation apparatus
411 master key information storage section
412 key information storage section
413 authentication information storage section
421 key generation section
422 authentication section
431 communication section
501 attribute management apparatus
511 attribute information storage section
512 authentication information storage section
521 authentication section
522 registration section
531 communication section
601 user terminal
611 public parameter storage section
612 user private key storage section
621 encryption section
622 decryption section
631 communication section

1-7. (canceled)

8. A cryptographic system using a cryptographic scheme capable of decrypting ciphertext on which one of two pieces of information corresponding to each other is set, with a decryption key on which the other of the two pieces of information is set, the cryptographic system comprising:
a key generation apparatus to generate:
a user private key on which one of key information u and key information y corresponding to each other is set, one of the key information u and the key information y having a unique private key ID set thereon, and
a re-encryption key to convert ciphertext which can be decrypted with an attribute private key on which one of user attribute information x and user attribute information v corresponding to each other is set, into re-ciphertext on which the other of the key information u and the key information y is set;
a ciphertext storage apparatus to store ciphertext on which the other of the user attribute information x and the user attribute information v is set;
a re-encryption apparatus to re-encrypt the ciphertext stored in the ciphertext storage apparatus, with the re-encryption key generated by the key generation apparatus to generate the re-ciphertext; and
a user terminal to decrypt the re-ciphertext generated by the re-encryption apparatus, with the user private key generated by the key generation apparatus.

9. The cryptographic system of claim 8,
wherein:
the key generation apparatus, when the user private key is invalidated, generates:
a new user private key on which one of new key information u′ and new key information y′ corresponding to each other is set, and
a new re-encryption key to convert the ciphertext which can be decrypted with the attribute private key into re-ciphertext on which the other of the new key information u′ and the new key information y′ is set; and
the re-encryption apparatus, after the new re-encryption key has been generated, re-encrypts the ciphertext stored in the ciphertext storage apparatus, with the new re-encryption key to generate the re-ciphertext.

10. The cryptographic system of claim 8,
wherein:
the key generation apparatus, when an attribute of a user has been changed, generates a new re-encryption key to convert ciphertext which can be decrypted with a new attribute private key on which one of new user attribute information x′ and new user attribute information v′ corresponding to each other is set, into the re-ciphertext on which the other of the key information u and the key information y is set; and
the re-encryption apparatus, after the new re-encryption key has been generated, re-encrypts the ciphertext stored in the ciphertext storage apparatus, with the new re-encryption key to generate the re-ciphertext.

11. The cryptographic system of claim 8,
wherein:
the key generation apparatus generates the user private key and the re-encryption key, for each user; and
the re-encryption apparatus receives identification information of a user from the user terminal, and re-encrypts the ciphertext stored in the ciphertext storage apparatus, with the re-encryption key corresponding to the user indicated by the received identification information.

12. A key generation apparatus for a cryptographic system using a cryptographic scheme capable of decrypting ciphertext on which one of two pieces of information corresponding to each other is set, with a decryption key on which the other of the two pieces of information is set, the key generation apparatus comprising:
processing circuitry to:
generate:
a user private key on which one of key information u and key information y corresponding to each other is set, one of the key information u and the key information y having a unique private key ID set thereon, and
a re-encryption key to convert ciphertext which can be decrypted with an attribute private key on which one of user attribute information x and user attribute information v corresponding to each other is set, into re-ciphertext on which the other of the key information u and the key information y is set; and
send the user private key generated by the key generation section to a user terminal, and send the re-encryption key generated by the key generation section to a re-encryption apparatus.

13. A re-encryption apparatus for a cryptographic system using a cryptographic scheme capable of decrypting ciphertext on which one of two pieces of information corresponding to each other is set, with a decryption key on which the other of the two pieces of information is set, the re-encryption apparatus comprising:
processing circuitry to:
store, for each piece of user's identification information, a re-encryption key to convert ciphertext which can be decrypted with an attribute private key on which one of user attribute information x and user attribute information v corresponding to each other is set, into re-ciphertext on which one of key information u and key information y corresponding to each other is set, one of the key information u and the key information y having a unique private key ID set thereon; and
receive the user's identification information and the ciphertext, and re-encrypt the received ciphertext with the re-encryption key stored in the re-encryption key storage section corresponding to the received user's identification information, to generate the re-ciphertext.

14. A user terminal for a cryptographic system using a cryptographic scheme capable of decrypting ciphertext on which one of two pieces of information corresponding to each other is set, with a decryption key on which the other of the two pieces of information is set, the user terminal comprising:
processing circuitry to:
receive re-ciphertext generated by re-encrypting ciphertext on which one of user attribute information x and user attribute information v corresponding to each other is set, the re-ciphertext on which one of key information u and key information y corresponding to each other is set, one of the key information u and the key information y having a unique private key ID set thereon; and
decrypt the re-ciphertext received by the communication section, with a user private key on which the other of the key information u and the key information y is set.
